(19) United States
(12) Patent Application Publication
(10) Pub. No.: US 2005/0137874 A1
(43) Pub. Date: Jun. 23, 2005

(54) Integrating object code in voice markup

(75) Inventors: William V. Da Palma, Coconut Creek, FL (US); Brett J. Gavagni, Coconut Creek, FL (US); Matthew W. Hartley, Boynton Beach, FL (US); Brien H. Muschett, Boynton Beach, FL (US)

Correspondence Address: CHRISTOPHER & WEISBERG, PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/744,144

(22) Filed: Dec. 22, 2003

(51) Int. Cl. G10L 11/00

(52) U.S. Cl. 704/270.1

(57) ABSTRACT

A method, system and apparatus for integrating object code in a voice application. In accordance with the present invention, a system for integrating application objects within voice markup can include a voice markup interpreter configured to process voice markup. The system further can include reflective logic programmed to match references to external application object methods with methods defined within external application objects. Finally, the system can include an object pre-processor disposed in the interpreter and configured both to invoke matched ones of the external application object methods referenced in voice markup, and also to map results from the invoked external application objects to references to the results in the voice markup.

### BACKGROUND OF THE INVENTION

1. Statement of the Technical Field

The present invention relates to the field of voice markup processing, and more particularly to the execution of operational code disposed within a voice markup application.

2. Description of the Related Art

Voice markup processing provides a flexible mode for handling voice interactions in a data processing application. Specifically designed for deployment in the telephony environment, voice markup provides a standardized way for voice processing applications to be defined and deployed for interaction for voice callers over the public switched telephone network (PSTN). In recent years, the VoiceXML specification has become the predominant standardized mechanism for expressing voice applications.

While voice markup applications initially had been limited to essential text-to-speech prompting and audio playback, more recent voice markup applications include basic forms processing. Yet, as it would be expected, the demands of advancing telephonic applications require more than simplistic forms and prompting. Accordingly, scripting capabilities have been incorporated into voice markup standardized implementations, much as scripting capabilities have been incorporated into visual markup standardized implementations.

The scripting support in VoiceXML provides the developer with the capability to process input validation and filtering, calculations, and parsing and reformatting of data in the VoiceXML gateway. Although these same functions could also be performed in the server, the overhead of the transaction with the server may dominate the time spent in performing the function. In addition, the actual interaction with the application server itself may involve much more than a simple common gateway interface execution, and might also include transaction handling, session management, and so on, even for such a simple request. Presently, the European Computer Manufacturer's Association (ECMA) standard for a scripting language for use in VoiceXML is known as ECMAScript.

Notably, while scripting technologies including ECMAScript provide handy albeit rudimentary data processing capabilities, scripting technologies alone do not provide the advantages of a stand-along application object such as those produced through a third generation programming model. Generally, conventional third generation programming models include Pascal, C, C++ and Java to name a few. Particularly in respect to distributed computing across multiple disparate computing environments, the Java programming language has proven itself a comprehensive programming model suitable for deployment about the enterprise. Notably, unlike ordinary scripting languages, in the Java programming language, advanced processing can be supported within an application object operating within the virtual machine environment including facilitated access to platform resources and superior exception handling.

Nevertheless, standardized voice markup language implementations do not support the integration of third generation programming models. In particular, VoiceXML does not support the incorporation of an application object and, more specifically, VoiceXML does not support the use of the Java programming model. As a result, VoiceXML applications cannot capitalize upon the programmatic advantages of Java and other such third generation application programming models. Accordingly, it would be desirable to integrate conventional application objects within voice markup to afford more advanced processing in coordination with the interpretation of a voice markup application.

### SUMMARY OF THE INVENTION

The present invention addresses the deficiencies of the art in respect to the processing active code in a voice markup document and provides a novel and non-obvious method, system and apparatus for integrating object code in a voice application. In accordance with the present invention, a system for integrating application objects within voice markup can include a voice markup interpreter configured to process voice markup. The system further can include reflective logic programmed to match references to external application object methods with methods defined within external application objects. Finally, the system can include an object pre-processor disposed in the interpreter and configured both to invoke matched ones of the external application object methods referenced in voice markup, and also to map results from the invoked external application objects to references to the results in the voice markup.

The system of the present invention can process voice markup documents configured for integrating conventional voice markup instructions along with method invocations for external application object methods. To that end, a voice markup document which has been configured for use with the system of the present invention can include a plurality of voice markup tags, a reference to an external object and a method defined in the object, and a further reference to a result produced by invoking the method to the external object. Preferably, the voice markup document also can include at least one reference to a parameterized method defined in the object. Notably, the references can be defined within an object tag set in the voice markup.

In a method for integrating application objects within voice markup, a reference to a method defined within an external application object can be located within the voice markup. Subsequently, an instance of the external application object can be created, preferably without argument. The method referenced in the external application object can be invoked and a result from the invocation can be stored. Finally, the result can be mapped in the voice markup and the voice markup can be processed in a voice markup interpreter.

In a preferred aspect of the invention, the method can include the step of invoking at least one parameterized method defined within the voice markup. Moreover, the method can include the step of reflectively inspecting the external application object to determine characteristics for the result. In this regard, the method yet further can include the step of reflectively inspecting the external application object both to determine characteristics for the result and also to determine a proper prototype for invoking the at least one parameterized method defined within the voice markup.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a voice markup processing system configured for integration with application objects in accordance with the inventive arrangements;

FIG. 2 is a pictorial illustration of a voice markup language document configured for integration with an application object in the system of FIG. 1;

FIG. 3 is a class illustration of the application object of FIG. 2; and,

FIG. 4 is a flow chart illustrating a process for integrating an application object in voice markup.

### DETAILED DESCRIPTION OF THE PREFERRED EMBODIMENTS

The present invention is a system, method and apparatus for integrating an external application object in voice markup. In accordance with the present invention, a reference to a method to an externally compiled application object can be disposed in the voice markup and wrapped with an identifying object tag. One or more parameterized method calls to the application object can be further incorporated in the voice markup and wrapped with one or more identifying parameter tags. Additionally, the resulting return value for the method invocations can be referenced within one or more playback instructions in the voice markup.

A voice markup interpreter configured to process the voice markup first can pre-process the reference to the application object reflectively to identify the method calls disposed within the application object and the corresponding method call prototypes. Based upon the identified prototypes for the method calls, the method calls can be invoked and the playback instructions can be reformed to include the resulting return value or values of the invocations. Subsequently, the reformed voice markup document can be processed conventionally within the voice markup interpreter. In this way, two-way voice interactions can be provided using the reformed voice markup while extending the logic of the voice markup to support advanced processing associated with the external application object.

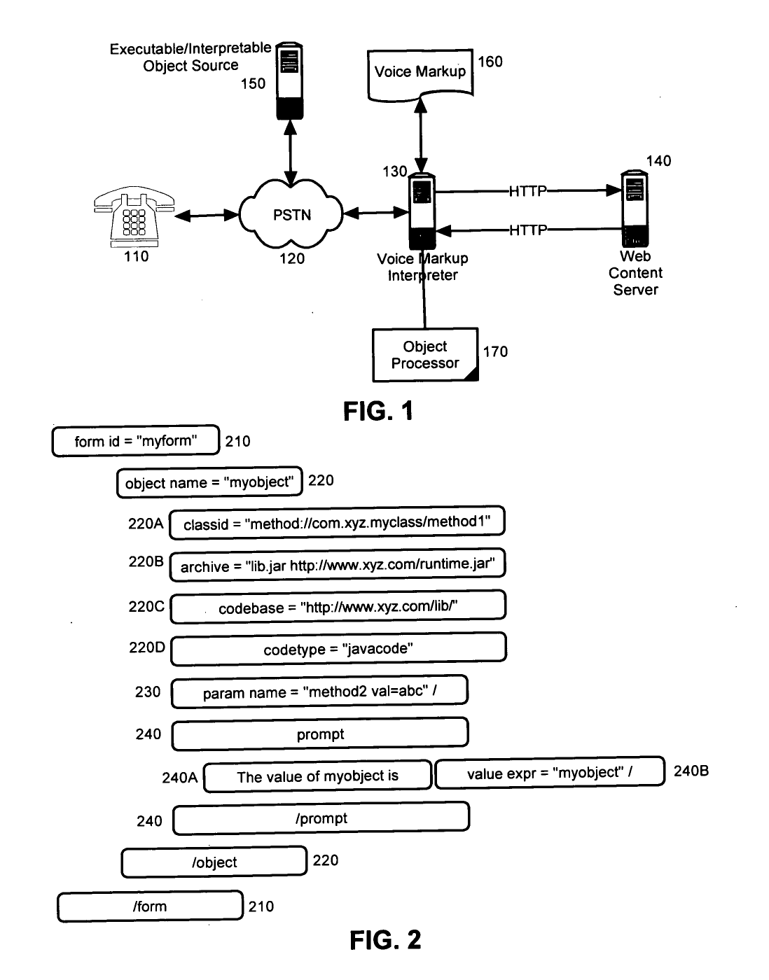

In further illustration, FIG. 1 is a schematic illustration of a voice markup processing system configured for integration with application objects in accordance with the inventive arrangements. The voice markup processing system can include a voice markup interpreter 130 configured for communicative linkage to one or more voice clients 110 over the PSTN 120. Though not shown, the voice markup interpreter 130 further can be configured for communicative linkage to one or more voice clients over a data communications network where the voice clients have been configured for telephonic access using the data communications network, as is well-known in the IP telephony art.

The voice markup interpreter 130 can be programmed for standalone processing of voice markup 160. The voice markup interpreter 130 further can be configured for cooperative processing between the voice markup 160 and data content provided by a content server 140 coupled to the voice markup interpreter 130. Notably, the voice markup interpreter 130 further can be configured to process externally referenced application objects disposed in a data store of application objects 150. In this regard, an object processor 170 can be coupled to or disposed within the voice markup interpreter 130.

The object processor 170 can include programming for pre-processing the voice markup 160 to identify references to application objects disposed within the data store of application objects 150. More particularly, the object processor 170 can locate a reference to an application object within the voice markup 160, reflectively identify within the referenced application object the method calls and data members defined within the referenced application object, and the prototypes for the method calls available for access within the referenced application object. Based upon the reflective identification of the method calls and their respective prototypes, method call references disposed within the voice markup 160 can be invoked along with specified parameters in order to produce method call results. The results of the method call invocations can be disposed in audible playback fields of a re-formatted version of the voice markup 160. Subsequently, the voice markup interpreter 130 can process the re-formatted version of the voice markup 160 conventionally.

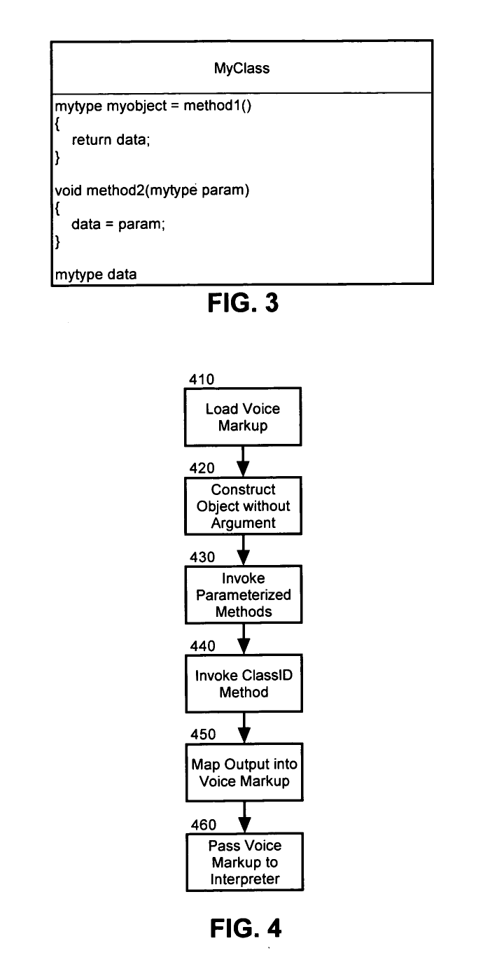

To further illustrate the structure of the voice markup 160 prior to its pre-processing in the object processor 170, FIG. 2 is a pictorial illustration of an exemplary voice markup language document configured for integration with an application object in the system of FIG. 1. To further facilitate the present discussion, a class diagram for an exemplary application object is shown in FIG. 3 to be viewed in conjunction with the pictorial illustration of FIG. 2. Referring first to FIG. 2, the voice markup can include a form identifier 210 identifying the voice markup, as well as an “object” identifier 220 identifying the particular object to be processed as is known in the art. Notably, the object identifier 220 can refer to an object returned for use in the voice markup during the pre-processing phase described herein.

Significantly, a class identifier 220A can refer to a method disposed in an external application object method such as a Java class object method. In this regard, the class identifier 220A can reference not only the application object method name, but also an encapsulating object and a file system or network location (or both) for the encapsulating object. The class illustrated in FIG. 3 can include such a class which can encapsulate the method referenced by the class identifier 220A. Optionally, an archive identifier 220B can be specified in which the encapsulated object can be stored, as can a codebase location 220C for the encapsulated object. Finally, a code type for the external application object method referenced by the object identifier 220 can be specified.

Importantly, one or more parameterized methods 230 can be specified in the voice markup. In this regard, the parameterized methods 230 can include both the identity of selected method calls available within the application object, and also parameter values for use in invoking the method calls. In this way, one or more parameterized method calls can be invoked on the application object from within the scripted object in the voice markup. In illustration, the class of FIG. 3 includes one parameterized method call able to resolved reflectively and invoked from within the voice markup. As a result, the voice markup can be extended to include an interactive element between the voice markup and the application object.

As will be expected by the skilled artisan, the voice markup can include a prompt block 240 enclosing data to be audibly presented. The data to be audibly presented can include a textual portion 240A in addition to a variable portion 240B. The variable portion 240B can depend upon the result produced through the invocation of the application object method referenced by the class identifier 220A. In particular, the result can take the form of a simple data type such as a string or an integer, or a complex data type such as a class. To the extent that the result takes the form of a class, the data members of the class can be referenced with respect to the object identifier 220 by way of a member access specifier as is known in the art.

In illustration of the methodology of the present invention, FIG. 4 is a flow chart illustrating a process for integrating an application object in voice markup. Beginning in block 410, voice markup can be loaded for processing an class identifier referencing a method within an external class object can be located. In block 420, the external application object can be constructed without reference to any constructor arguments. Subsequently, all parameterized methods specified in the voice markup can be invoked in the constructed argument in block 430.

More particularly, once the external class object has been constructed, the external class object can be reflectively inspected to identify the methods and respective method prototypes defined within the external class object. The parameterized methods specified within the voice markup can be matched to the method prototypes to determine an appropriate manner in which to invoke the specified parameterized methods. In any case, once all of the parameterized methods have been invoked, in block 440 the method referenced by the class identifier can be invoked to produce a return result.

In block 450, the return result can be mapped into portions of the voice markup where indicated. Specifically, to the extent the return result comports with a complex data type, each data member of the complex data type can be de-referenced within one or more voice markup operative tags, for instance the prompt tag. As a result, the tag can be rewritten to include the evaluated tag reformed to include the de-referenced data from the return result. Subsequently, in block 460 the voice markup can be processed conventionally in the voice markup interpreter to produce two-way voice interactions with one or more end users.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A system for integrating application objects within voice markup comprising:
a voice markup interpreter configured to process voice markup;
reflective logic programmed to match references to external application object methods with methods defined within external application objects; and,
an object pre-processor disposed in said interpreter and configured both to invoke matched ones of said external application object methods referenced in voice markup and also to map results from said invoked external application objects to references to said results in said voice markup.

2. The system of claim 1, wherein said voice markup comprises an object tag set wrapping a reference to an external application object and a method disposed within said external application object.

3. The system of claim 1, wherein said object tag set further comprises a configuration for wrapping at least one reference to a parameterized method disposed within said external application object.

4. A voice markup document comprising:
a plurality of voice markup tags;
a reference to an external object and a method defined in said object; and,
a further reference to a result produced by invoking said method to said external object.

5. The voice markup document of claim 4, further comprising at least one reference to a parameterized method defined in said object.

6. The voice markup document of claim 4, wherein said references are defined within an object tag set in the voice markup.

7. The voice markup document of claim 4, further comprising at least one of an archive identifier, a codebase identifier and a codetype identifier.

8. A method for integrating application objects within voice markup comprising the steps of:
locating within the voice markup a reference to a method defined within an external application object;
creating an instance of said external application object;
invoking said method and storing a result from said invocation;
mapping said result in the voice markup; and,
processing the voice markup with said mapped result in a voice markup interpreter.

9. The method of claim 8, further comprising the step of invoking at least one parameterized method defined within the voice markup.

10. The method of claim 8, further comprising the step of reflectively inspecting said external application object to determine characteristics for said result.

11. The method of claim 9, further comprising the step of reflectively inspecting said external application object both to determine characteristics for said result and also to determine a proper prototype for invoking said at least one parameterized method defined within the voice markup.

12. A machine readable storage having stored thereon a computer program for integrating application objects within voice markup, the computer program comprising a routine set of instructions which when executed by a machine cause the machine to perform the steps of:
locating within the voice markup a reference to a method defined within an external application object;
creating an instance of said external application object;
invoking said method and storing a result from said invocation;
mapping said result in the voice markup; and,
processing the voice markup with said mapped result in a voice markup interpreter.

13. The machine readable storage of claim 12, further comprising the step of invoking at least one parameterized method defined within the voice markup.

14. The machine readable storage of claim 12, further comprising the step of reflectively inspecting said external application object to determine characteristics for said result.

15. The machine readable storage of claim 13, further comprising the step of reflectively inspecting said external application object both to determine characteristics fpr said result and also to determine a proper prototype for invoking said at least one parameterized method defined within the voice markup.
